(19) United States
(12) Patent Application Publication
(10) Pub. No.: US 2026/0184244 A1
(43) Pub. Date: Jul. 2, 2026

(54) SEAT AND COVER FABRIC FIXING MEMBER

(71) Applicant: DELTA KOGYO CO., LTD., Hiroshima (JP)

(72) Inventor: Ryoya MASUGATA, Hiroshima (JP)

(73) Assignee: DELTA KOGYO CO., LTD., Hiroshima (JP)

(21) Appl. No.: 18/857,503

(22) PCT Filed: Apr. 28, 2023
(86) PCT No.: PCT/JP2023/016820

§ 371 Date: Oct. 17, 2024

(30) Foreign Application Priority Data
May 12, 2022 (JP) 2022-078778

(51) Int. Cl. B60N 2/58; B60N 2/75

(52) U.S. Cl. CPC B60N 2/5825; B60N 2/757

(57) ABSTRACT

A cover fixing member includes a cover attachment part and an engaging part. When the engaging part engages with an engaged section by sandwiching the engaged section between an outer engaging section and an inner engaging section, a tensile force of the cover is generated, and an inner protrusion of the inner engaging section is pressed to an inner surface of the engaged section to be a fulcrum and a protrusion at a distal end of the outer engaging section is pressed to an outer surface of the engaged section to receive a reaction force from the outer surface and to be a point of effort in response to the tensile force. The protrusion receives such the reaction force that keeps a balance between the rotation moment based on the tensile force of the cover and the rotation moment based on the acting force acting onto the cover attachment part.

### TECHNICAL FIELD

The present invention relates to a seat including a base body having a front surface covered by a cover, and relates to a cover fixing member.

### BACKGROUND ART

A seat to be attached to a vehicle, such as an automobile, has been conventionally known for a structure including a base body having a front surface covered by a cover and an engaging member that engages an end of the cover with the base body.

For instance, a fixing structure including a clip 43 illustrated in FIG. 14 has been known for engagement of an end of a cover with a resin base body using an engaging member, like the clip, in a portion above an armrest accommodation part in the middle of a three-seater rear seat (e.g., see FIG. 1) for a vehicle. In the fixing structure, the clip 43 fastens an end of a cover 42 that covers a front X1 of a base body 41 located upward Z1 from an armrest accommodation part 40 that accommodates an armrest AR to a lower portion of the base body 41 at a specific point (i.e., a specific point engagement) in the base body 41. Such engagement results in making the clip 43 easily come off with a tensile force of the cover 42 and thus facing difficulty in keeping the tension of the cover 42 constant. Further, the cover 42 has a hole for the engagement using the clip, and thus tends to have a parting line. The cover fixing structure accordingly has a poor external appearance, and the engaging member is highly likely to come off.

Another fixing structure including a cover finisher having a J-shape in cross-section for surface-fixing has been known as an engaging member having a larger engagement area than the clip. In the fixing structure, the cover finisher is fixed to an end of a cover so that the cover finisher fits to a slit in a base body. This means that the fixing structure requires the slit for the engagement of the cover finisher with the base body, and hence needs an additional member to hide the slit. The cover fixing structure has a poor external appearance, an increase in a manufacturing cost, and further inconvenience.

To solve the disadvantages (including poor appearance and difficulty in maintaining an engagement state), a cover fixing structure for maintaining an engagement state of an end of a cover without increasing the number of components and impairing an external appearance has been demanded.

To meet the demand, for example, a cover fixing structure illustrated in FIG. 15, as described in Patent Literature 1, has been known. A seat illustrated in FIG. 15 includes a seat cushion 90 attached onto a frame 71 and a cover 80 that covers a surface of the seat cushion 90. The cover 80 has an end fixed to a lower end 71a of the frame 71 by a fixing member 50, and a cover member 60 covers a space under the seat cushion 90. This makes the fixed portion of the end of the cover invisible from the outside.

Specifically, the fixing member 50 illustrated in FIG. 15 has a Y-shape in cross-section, and includes an inner end 51 located inside the frame 71, an outer end 54 located outside the frame 71, and a lower protrusion 52 protruding downward. The inner end 51 has a thin part 55 having a sewn portion 55a to which the end of the cover 80 is sewn. The inner end 51 has an engaging section 53 that engages with a lower end 71a of the frame 71. Further, the inner end 51 and the outer end 54 sandwich the lower end 71a. In this manner, the fixing member 50 engages with the lower end 71a of the lower end 71a. The lower protrusion 52 engages with an upper end 61 of the cover member 60. In this manner, the fixing member 50 maintains the fixed state of the end of the cover 80 through engagement with the lower end 71a of the frame 71 and engagement with the upper end 61 of the cover member 60.

However, in the cover fixing structure illustrated in FIG. 15, when a strong tensile force A acts onto the cover 80, the fixing member 50 may rotate in a direction denoted by the arrow B. Then, the engaging section 53 of the fixing member 50 and the lower end 71a of the frame 71 may disengage from each other, and the lower protrusion 52 and the upper end 61 of the cover member 60 engaging with each other 60 may disengage from each other. In this respect, the structure illustrated in FIG. 15 still remains in need of improvement to maintain the engaged state of the end of the cover.

### CITATION LIST

### Patent Literature

Patent Literature 1: Japanese Patent Publication No. 5196227

### SUMMARY OF INVENTION

The present invention has been accomplished in view of the circumstances described above, and has an object of providing a seat and a cover fixing member that achieve stable fixing of an end of a cover only by the fixing member without increasing the number of components.

To achieve the aforementioned object, a seat in the present invention includes: a base body; a cover that covers a front surface of the base body; and a cover fixing member that fixes an end of the cover to the base body at an end of a rear surface of the base body. The base body has an engaged section protruding rearward from the end of the rear surface of the base body, and having an outer surface facing an outside of the base body and an inner surface facing an inside of the base body. The end of the cover extends toward a rear of the base body over the engaged section. The cover fixing member includes: a cover attachment part to which the end of the cover is attached; and an engaging part that is closer to the engaged section than the cover attachment part and engages with the engaged section. The end of the cover is engaged with the engaged section via the cover attachment part. The engaging part has an outer engaging section being in contact with the outer surface of the engaged section and an inner section being in contact with the inner surface of the engaged section. The inner engaging section has an inner protrusion protruding to the inner surface of the engaged section. The outer engaging section has, at a distal end thereof, a reaction force receiving portion that receives a reaction force from the outer surface of the engaged section. The engaging part is configured to engage with the engaged section in a state of sandwiching the engaged section between the outer engaging section and the inner engaging section so that the reaction force receiving portion receives the reaction force from the outer surface of the engaged section about the inner protrusion as a fulcrum in response to a tensile force of the cover. The reaction force receiving portion is configured to give an acting force onto the cover attachment part with the reaction force in a direction perpendicularly intersecting a direction of the tensile force and toward the engage part, and receive the reaction force to keep a balance between a rotation moment based on the tensile force of the cover received by the cover attachment part about the inner protrusion as a rotation center and a rotation moment based on the acting force acting onto the cover attachment part.

### BRIEF DESCRIPTION OF DRAWINGS

FIG. 1 is a perspective view of an overall configuration of a three-seater rear seat as an example seat according to an embodiment of the present invention, and illustrates a state before an armrest is accommodated in an armrest accommodation part.

FIG. 2 is a perspective view of the three-seater rear seat in FIG. 1 and illustrates a state after the arm rest is accommodated in the armrest accommodation part.

FIG. 3 is an enlarged perspective view of a seam portion between a cover and a lower constituent part of a base body at an upper end of the armrest accommodation part in FIG. 1.

FIG. 4 is a cross-sectional explanatory view illustrating an arrangement of an upper constituent part of the base body, a cover, and a cover fixing member at the upper end of the armrest accommodation part.

FIG. 5 is an enlarged cross-sectional view of the upper constituent part of the base body, the cover, and the cover fixing member in FIG. 4, and illustrates the cover fixing member in cross-section taken along the line V-V in FIG. 6.

FIG. 6 is a perspective view of the cover fixing member in FIG. 5.

FIG. 7 illustrates the cover fixing member in cross-section taken along the line VII-VII in FIG. 6, and is a cross-sectional explanatory view illustrating a positional relation among the cover fixing member, the upper constituent part of the base body, and the cover in the location of a slit in the cover fixing member.

FIG. 8 is a cross-sectional explanatory view illustrating a state where an inner protrusion to be a fulcrum when a cover attachment part of the cover fixing member in FIG. 5 receives a tensile force of the cover is pressed to an inner surface of an engaged section.

FIG. 9 is a cross-sectional explanatory view illustrating a state where a protrusion constituting a reaction force receiving portion at a distal end of an outer engaging section in FIG. 8 receives a reaction force from an outer surface of the engaged section to be a point of effort.

FIG. 10 is a cross-sectional explanatory view illustrating a state where the cover attachment part in FIG. 9 receives an acting force in a direction perpendicularly intersecting a direction of the tensile force of the cover and toward the engaged section to be a point of load.

FIG. 11 is a cross-sectional explanatory view illustrating the inner protrusion, the protrusion, and the cover attachment part in FIG. 8 to FIG. 10 to be the fulcrum, the point of effort, and the point of load respectively.

FIG. 12 is a cross-sectional explanatory view illustrating an operation of inserting fingers between the cover and the armrest to take the armrest out at the upper end of the armrest accommodation part in FIG. 4.

FIG. 13 is a cross-sectional explanatory view of a configuration of a modification of the seat in the present invention, the configuration including an outer engaging section having a tilting distal end constituting a reaction force receiving portion.

FIG. 14 is a cross-sectional view of a structure including a clip that fastens a cover at a specific point in a conventional seat.

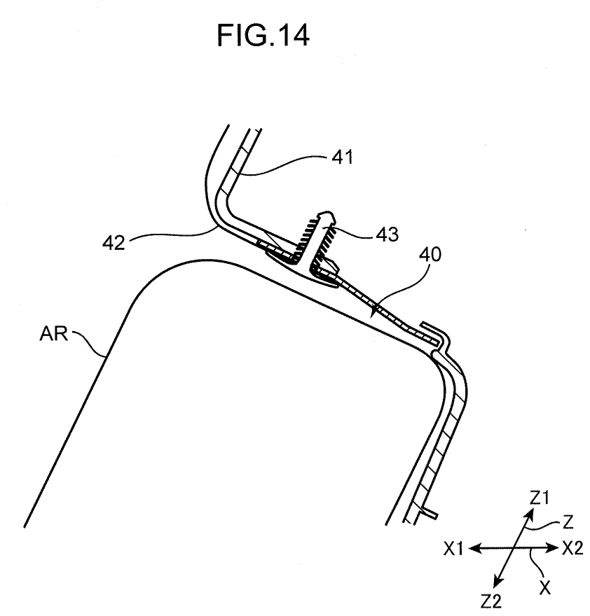

FIG. 15 is a cross-sectional view of a structure including a fixing member having a Y-shape in cross-section to fix a cover to a lower end of a frame in a conventional seat.

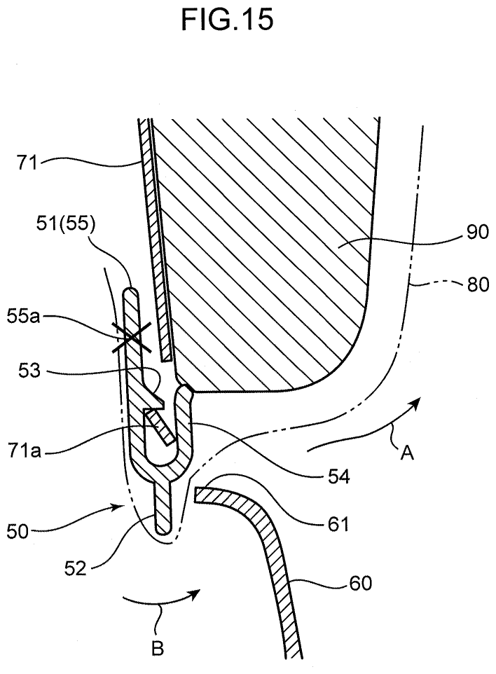

### DESCRIPTION OF EMBODIMENTS

Hereinafter, a seat and a cover fixing member according to an embodiment of the present invention will be described in detail with reference to the accompanying drawings.

### Overall Configuration of a Seat

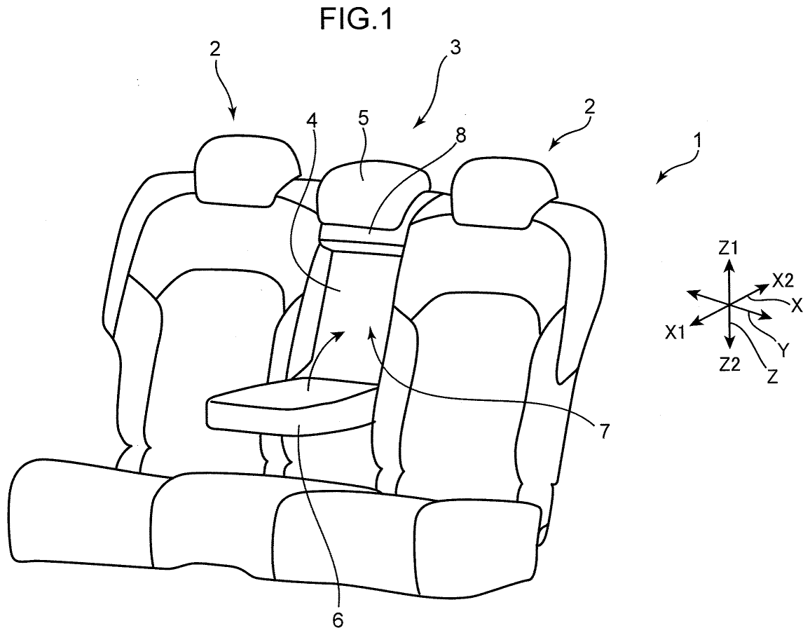

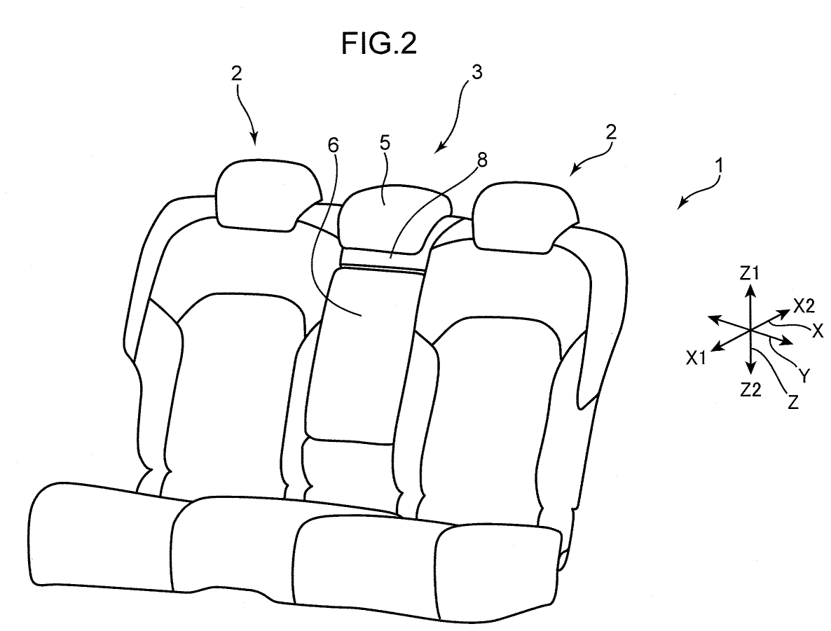

A seat 1 illustrated in FIG. 1 to FIG. 2 is a three-seater rear seat for a vehicle as an example seat in an embodiment of the present invention. The seat 1 includes main seats 2 at opposite positions and a center seat 3 in the middle position therebetween. The drawings to be referred to in the embodiment show a front-rear direction denoted by an arrow X (frontward X1, rearward or rear X2), a width direction denoted by an arrow Y, and an up-down direction denoted by an arrow Z (upward Z1, downward Z2) relative to the seat 1.

As illustrated in FIG. 1 to FIG. 4, the center seat 3 includes: a base body 4 including an armrest accommodation part 7; a headrest 5; an armrest 6; a cover 8 that covers an upper part (specifically, an upper constituent part 4b) of the base body 4; and a cover fixing member 9 (hereinafter, referred to as a “fixing member 9”) configured to fix the cover 8 to the base body 4.

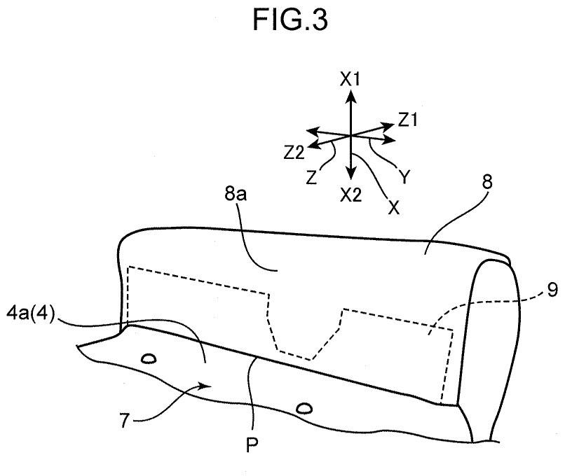

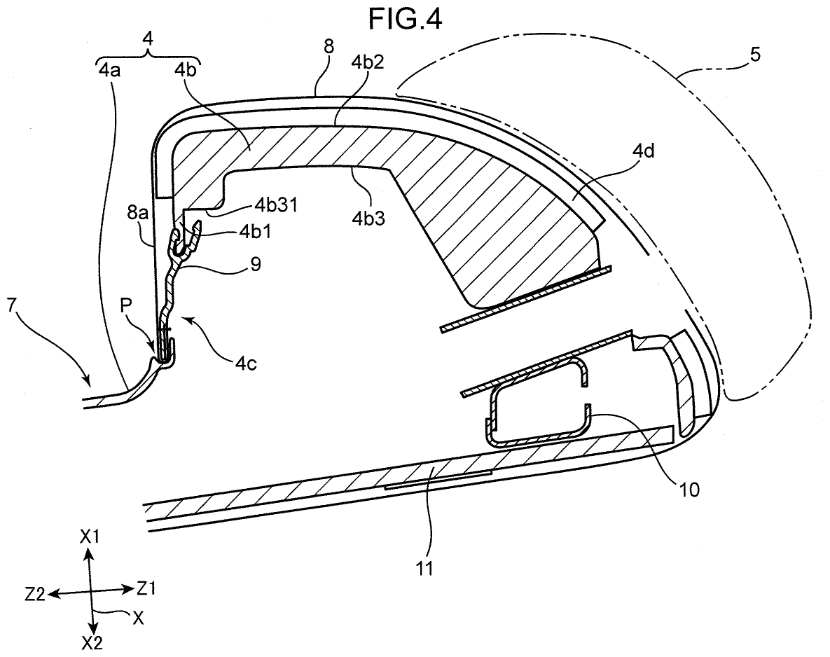

As illustrated in FIG. 3 to FIG. 4, the armrest accommodation part 7 is at a position adjacent to an outside (located downward Z2 in FIG. 3 to FIG. 4) of an end 8a (hereinafter, referred to as a “cover end 8a”) of a cover 8 extending toward the rear X2 of the base body 4. The armrest 6 illustrated in FIG. 1 to FIG. 2 is accommodated in the armrest accommodation part 7 in a standing posture to support the back of an occupant. Besides, the armrest 6 taken out from the armrest accommodation part 7 and lying frontward X1 is available as an armrest for occupants on the opposite main seats 2.

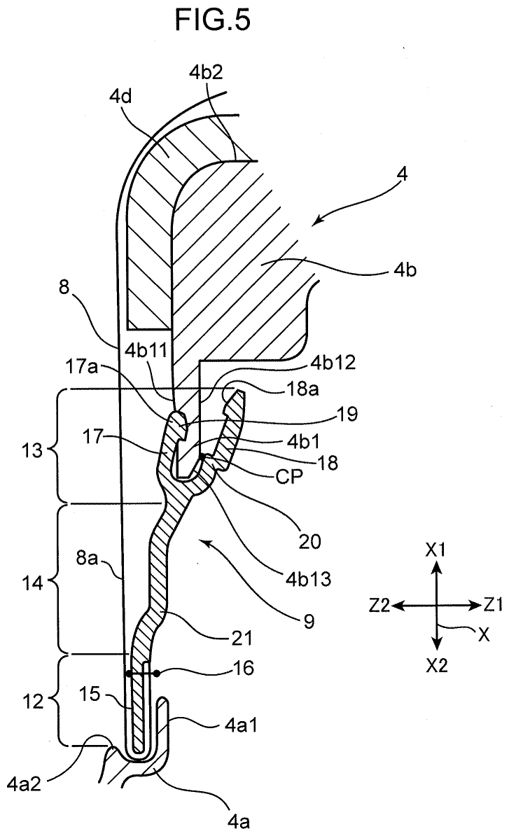

As illustrated in FIG. 4 to FIG. 5, the base body 4 has a lower constituent part 4a and the upper constituent part 4b located upward Z1 from the lower constituent part 4a. The lower constituent part 4a and the upper constituent part 4b are integrally made of resin to constitute the base body 4 having a vertically rectangular parallelepiped shape as a main body of a seatback for supporting the back of the occupant. As illustrated in FIG. 4, the base body 4 is supported by the frame 10, and the rear X2 of the base body 4 is covered by the backboard 11 and the cover 8.

The lower constituent part 4a has a substantially vertical plate shape and constitutes a bottom wall (a wall located rearward X2) of the armrest accommodation part 7. As illustrated in FIG. 5, the lower constituent part 4a in the embodiment has a receiving section 4a1 that receives a leading end of a cover attachment part 12 of the fixing member 9 to be described later and an engagement section 4a2 with which the leading end engages.

As illustrated in FIG. 4, the upper constituent part 4b is located upward X from the lower constituent part 4a and protrudes frontward X1 farther than the lower constituent part 4a to form a step difference in the front-rear direction X in combination with the lower constituent part 4a. The step difference is utilized to define the armrest accommodation part 7 for accommodating the armrest 6 having the rectangular parallelepiped block shape at a position downward Z2 from the upper constituent part 4b and frontward X1 from the lower constituent part 4a.

The upper constituent part 4b has a front surface 4b2 on which projections 4d (or a pleat) extending in the up-down direction Z are arranged. A plurality of the projections 4d is arrayed in the width direction of the seat 1.

As illustrated in FIG. 4 to FIG. 5, the upper constituent part 4b has a rear surface 4b3 provided with an engaged section 4b1. The engaged section 4b1 protrudes rearward X2 from an end 4b31 of the rear surface 4b3 located downward Z2 in the upper constituent part 4b. The engaged section 4b1 has an outer surface 4b11 facing an outside (downward Z2 in FIG. 5) of the upper constituent part 4b and an inner surface 4b12 facing an inside (upward Z1 in FIG. 5) thereof. Further, the inner surface 4b12 has a slope 4b13 at a leading end thereof (an end located rearward X2), the slope 4b13 sloping in a direction in which the engaged section 4b1 tapers as advancing toward the leading end (rearward X2). The engaged section 4b1 and the lower constituent part 4a define a gap 4c therebetween. The fixing member 9 fits in the gap 4c.

As illustrated in FIG. 4, the cover 8 covers the front surface 4b2 of the upper constituent part 4b of the base body 4 and covers a rear X2 of the backboard 11.

As illustrated in FIG. 5, the cover end 8a advances rearward X2 from a lower end (an end located downward Z2) of the front surface 4b2 of the upper constituent part 4b, and extends toward the rear X2 of the base body over the engaged section 4b1.

### Configuration of the Fixing Member 9

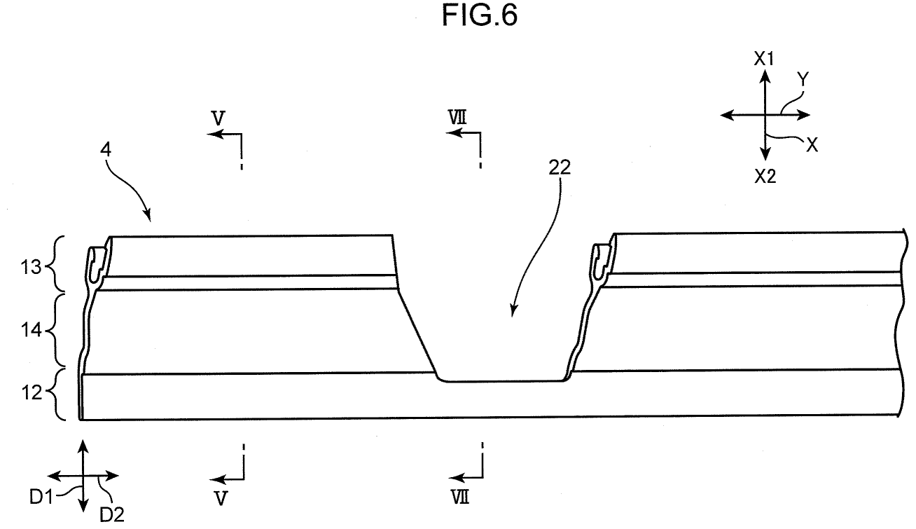

The fixing member 9 is configured to fix the cover end 8a to the engaged section 4b1 of the upper constituent part 4b at the end 4b31 of the rear surface 4b3 of the upper constituent part 4b of the base body 4 as illustrated in FIG. 4 to FIG. 5. Specifically, as illustrated in FIG. 5 to FIG. 6, the fixing member 9 includes the cover attachment part 12 to which the cover end 8a is attached, an engaging part 13 that engages with the engaged section 4b1, and a connection arm part 14 that connects the cover attachment part 12 and the engaging part 13 to each other therebetween. The engaging part 13 is closer (frontward X1 in FIG. 5) to the engaged section 4b1 than the cover attachment part 12.

As illustrated in FIG. 6, the fixing member 9 in the embodiment is formed of a long band-shaped member extending in a second direction D2 perpendicularly intersecting a first direction D1 in which the cover attachment part 12 and the engaging part 13 align. The first direction D1 agrees with the front-rear direction X of the seat 1 in the attached state of the fixing member 9 in FIG. 5. The second direction D2 agrees with the width direction Y of the seat 1 in FIG. 3 in the attached state of the fixing member 9 in FIG. 5.

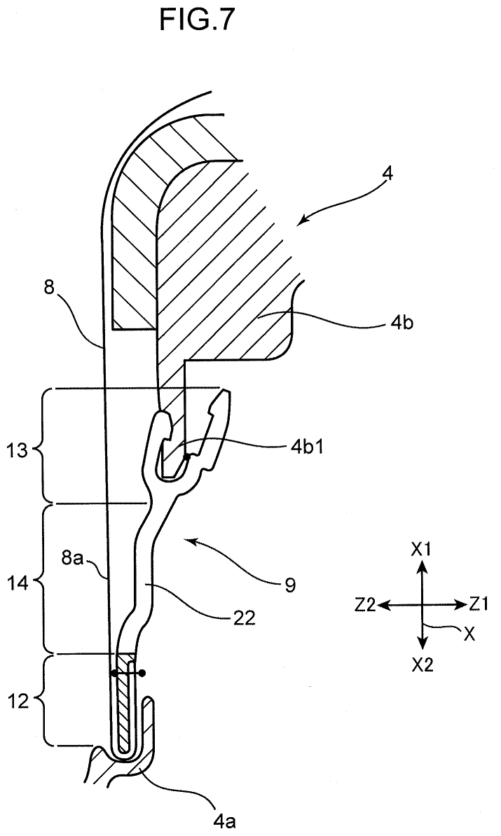

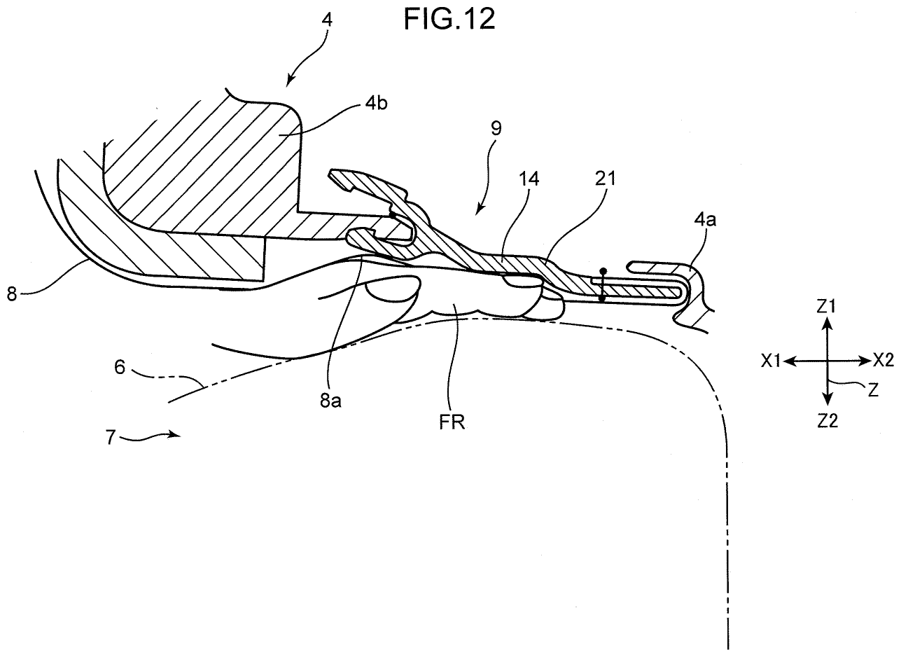

The band-shaped member constituting the fixing member 9 has a slit 22 (see FIG. 6 to FIG. 7) around a central portion thereof in the second direction D2, the slit resulting from removing the engaging part 13 and the connection arm part 14 in the central portion. At the portion of the slit 22 without the engaging part 13 and the connection arm part 14, the cover end 8a easily flexes upward Z1 when a user inserts fingers FR (see FIG. 12) thereof into the armrest accommodation part 7.

The cover attachment part 12 has such a shape as to receive the cover end 8a which is attachable thereto, specifically, has a flat section 15 that linearly extends in the front-rear direction X as illustrated in FIG. 5 to linearly guide the cover end 8a rearward X2. The cover end 8a is fixed at a sewn portion 16 through sewing in a state of wrapping around the cover attachment part 12. The cover attachment part 12 may have such a thickness as to allow the cover end 8a to be sewn to the cover attachment part 12. The cover end 8a may be fixed to the cover attachment part 12 by another fixing way except the sewing, for example, may be fixed through adhesion or with a metal member.

The cover end 8a is attached to the engaged section 4b1 via the cover attachment part 12 in a state of being tensioned rearward X2 while advancing outward (downward Z2 in FIG. 4 to FIG. 5) from the upper constituent part 4b of the base body 4 at a distance from the outer surface 4b11 of the engaged section 4b1. The leading end (the end located rearward X2) of the cover attachment part 12 is supported by the receiving section 4al of the lower constituent part 4a of the base body 4 and the leading end engages with the engagement section 4a2 to avoid coming off the receiving section 4a1.

The connection arm part 14 has a stepped portion 21 curving in a direction away from the cover end 8a. This allows the cover end 8a to easily flex upward Z1 when the user inserts the fingers FR (see FIG. 12) into the armrest accommodation part 7.

As illustrated in FIG. 5, the engaging part 13 includes an outer engaging section 17 and an inner engaging section 18 being apart from each other, that is, an outer engaging section 17 being in contact with the outer surface 4b11 of the engaged section 4b1 and an inner engaging section 18 being contact with the inner surface 4b12 of the engaged section 4b1. The engaging part 13 engages with the engaged section 4b1 in a state of sandwiching the engaged section 4b1 between the outer engaging section 17 and the inner engaging section 18.

The inner engaging section 18 has an inner protrusion 20 protruding to the inner surface 4b12 of the engaged section 4b1. In the embodiment, the inner protrusion 20 protrudes inward in a space between the outer engaging section 17 and the inner engaging section 18, and is located at a proximal end of the inner engaging section 18. The inner protrusion 20 is in point contact with the slope 4b13 of the leading end (located rearward X2) of the inner surface 4b12 of the engaged section 4b1 at a contact point CP.

The inner engaging section 18 further has a slanting surface 18a slanting in a direction away from the inner surface 4b12 of the engaged section 4b1 as advancing toward a distal end of the inner engaging section 18.

The outer engaging section 17 has, at a distal end 17a thereof, a protrusion 19 constituting the reaction force receiving portion that receives a reaction force F2 from the outer surface 4b11 of the engaged section 4b1.

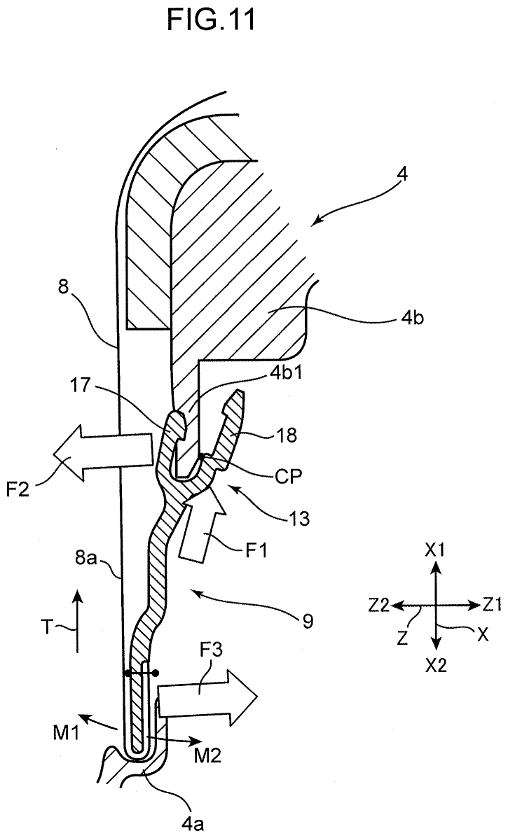

In the embodiment, the reaction force receiving portion includes the protrusion 19 protruding from the distal end 17a of the outer engaging section 17 to the outer surface 4b11 of the engaged section 4b1. The protrusion 19 protrudes inward in the space between the outer engaging section 17 and the inner engaging section 18. The protrusion 19 is strongly pressed into the outer surface 4b11 of the engaged section 4b11 with a rotation moment M1 (see FIG. 11) of the fixing member 9 around the contact point CP at the inner protrusion 20, the rotation moment M1 being generated on the basis of the tensile force of the cover end 8a progressing frontward X1.

In the embodiment, the distal end 17a of the outer engaging section 17 tilts in a direction toward the outer surface 4b11 of the engaged section 4b1 relative to the direction (the up-down direction X in FIG. 5) in which the cover attachment part 12 extends. The tilting distal end 17A can constitute the reaction force receiving part (that is, can be included in the reaction force receiving portion).

In the fixing member 9 in the embodiment, the engaging part 13 engages with the engaged section 4b1 in the state of sandwiching the engaged section 4b1 between the outer engaging section 17 and the inner engaging section 18. In this state, the inner protrusion 20 of the inner engaging section 18 is in point contact with the slope 4b13 of the leading end of the inner surface 4b12 of the engaged section 4b1 at the contact point CP. Further, the protrusion 19 at the distal end 17a of the outer engaging section 17 is strongly pressed into the outer surface 4b11 of the engaged section 4b1.

As illustrated in FIG. 5, the flat section 15 of the cover attachment part 12 is located farther from the inner protrusion 20 of the inner engaging section 18 than the protrusion 19 and the distal end 17a of the outer engaging section 17 constituting the reaction force receiving portion in a view in the direction (the up-down direction Z in FIG. 5) perpendicularly intersecting the direction (the front-rear direction X in FIG. 5) in which the cover attachment part 12 and the engaging part 13 align.

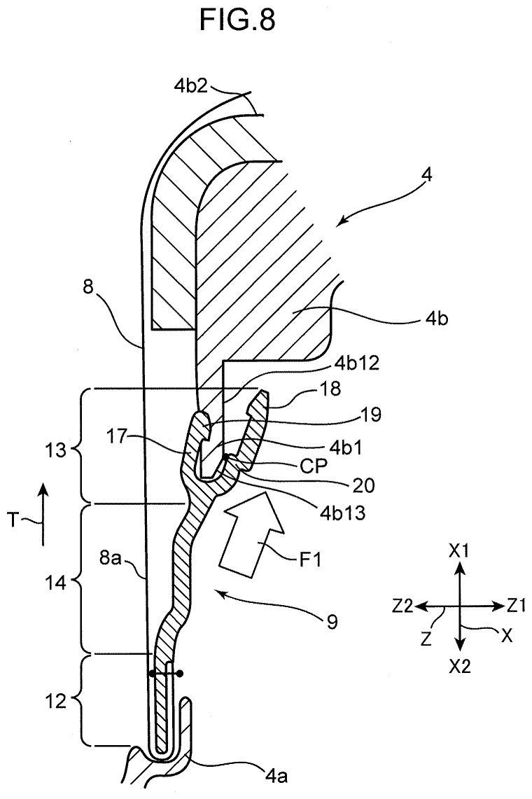

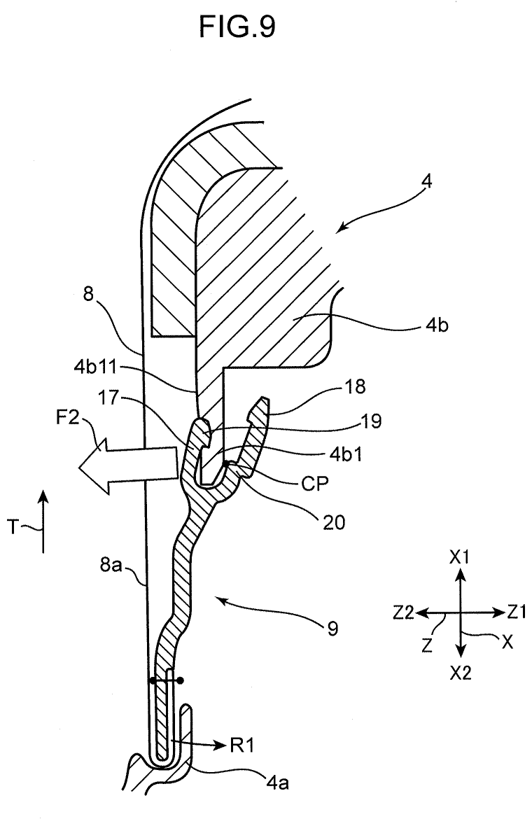

The engaging part 13 is configured to engage with the engaged section 4b1 in the state of sandwiching the engaged section 4b1 between the outer engaging section 17 and the inner engaging section 18 so that the protrusion 19 (or the reaction force receiving portion) at the distal end of the outer engaging section 17 receives the reaction force F2 (see FIG. 9) from the outer surface 4b11 of the engaged section 4b1 to be a point of effort about the contact point CP at the inner protrusion 20 of the inner engaging section 18 as the fulcrum in response to a tensile force T (see FIG. 8) of the cover end 8a.

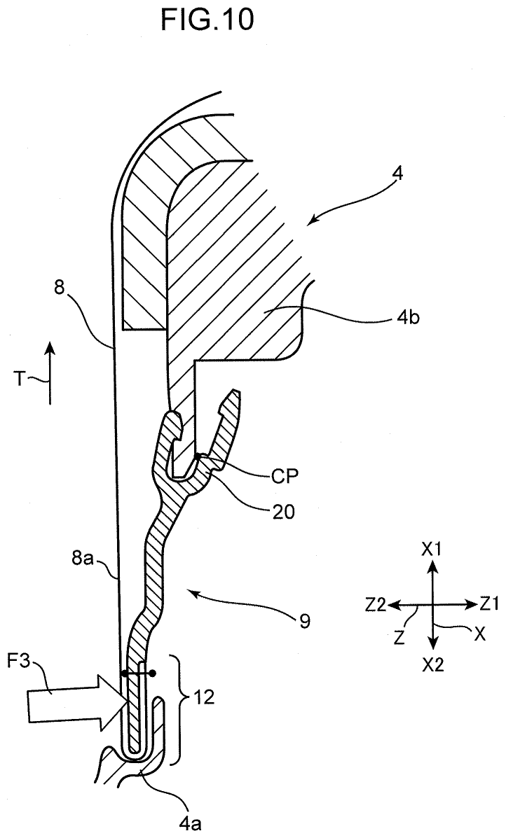

As illustrated in FIG. 11, the protrusion 19 constituting the reaction force receiving part is configured to: give an acting force F3 onto the cover attachment part 12 with the reaction force F2 from the outer surface 4b11 of the engaged section 4b1 in a direction (the up-down direction Z in FIG. 10) perpendicularly intersecting the direction of the tensile force T of the cover end 8a and toward the engaged section 4b1 (upward Z1); and receive the reaction force to keep a balance between the rotation moment M1 based on the tensile force T of the cover 8 received by the cover attachment part 12 about the contact point CP at the inner protrusion 20 as the rotation axis and a rotation moment M2 based on the acting force F3 acting onto the cover attachment part 12. Specific operational effects will be described in detail below.

### Characteristics of the Embodiment

(1) As illustrated in FIG. 4 to FIG. 5, the seat 1 in the embodiment includes, in the center seat 3 in FIG. 1 to FIG. 2, the fixing member 9 to fix the cover end 8a to the engaged section 4b1 of the upper constituent part 4b by engaging with the engaged section 4b1 protruding rearward X2 from the end 4b31 of the rear surface 4b3 of the upper constituent part 4b of the base body 4. In the configuration of the fixing member, the engaging part 13 engaging with the engaged section 4b1 is less likely to disengage therefrom even when the cover attachment part 12 receives the tensile force T of the cover 8 in a direction toward the front surface 4b2 of the upper constituent part 4b. Specifically, the engaging part 13 includes the outer engaging section 17 being in contact with the outer surface 4b11 of the engaged section 4b1 and the inner engaging section 18 being in contact with the inner surface 4b12 of the engaged section 4b1, and engages with the engaged section 4b1 in the state of sandwiching the engaged section 4b1 between the outer engaging section 17 and the inner engaging section 18. The inner engaging section 18 has the inner protrusion 20 protruding to the inner surface 4b12 of the engaged section 4b1. The outer engaging section 17 has, at the distal end 17a thereof, the protrusion 19 constituting the reaction force receiving portion that receives the reaction force F2 from the outer surface 4b11 of the engaged section 4b1.

As illustrated in FIG. 8, the fixing member 9 in the embodiment is configured such that, when the engaging part 13 engages with the engaged section 4b1 in the state of sandwiching the engaged section 4b1 between the outer engaging section 17 and the inner engaging section 18 while the cover end 8a attached to the cover attachment part 12 is tensioned, the tensile force Tis generated at the cover end 8a in a direction (frontward X1) toward the front surface 4b2 of the upper constituent part 4b of the base body 4. The inner protrusion 20 of the inner engaging section 18 is pressed (see the pressing force F1), at the contact point CP, to the inner surface 4b12 (specifically, to the slope 4b13 at the leading end of the inner surface 4b12) of the engaged section 4b1 to be a fulcrum in response to the tensile force T.

At this time, as illustrated in FIG. 9, the protrusion 19 (or the reaction force receiving portion) at the distal end of the outer engaging section 17 is pressed to the outer surface 4b11 of the engaged section 4b1 to receive the reaction force F2 from the outer surface 4b11 and to be the point of effort. The protrusion 19 gives the acting force F3 onto the cover attachment part 12 with the reaction force F2 in the direction (the up-down direction Z in FIG. 10) perpendicularly intersecting the direction of the tensile force T and toward the engaged section 4b1 (upward Z1).

As illustrated in FIG. 11, this achieves the balance between the rotation moment M1 based on the tensile force T of the cover 8 received by the cover attachment part 12 about the contact point CP at the inner protrusion 20 as the rotation center and the rotation moment M2 based on the acting force F3 acting onto the cover attachment part 12.

The balance between the two rotation moments M1, M2 applied to the cover attachment part 12 in the fixing member 9 prevents the fixing member 9 from rotating. This enables the engaging part 13 of the fixing member 9 to sandwich the engaged section 4b1 of the base body between the outer engaging section 17 and the inner engaging section 18 from inside and outside and to maintain the state of engaging with the engaged section, so that the engaging part 13 is prevented from disengaging from the engaged section 4b1. The configuration eventually eliminates the need for a retainer at the engaged section 4b1 independently of the fixing member 9, and thus achieves stable fixing of the cover end 8a only by the fixing member 9 without increasing the number of components of the seat 1.

(2) In the seat 1 in the embodiment, the reaction force receiving portion includes the protrusion 19 protruding from the distal end 17a of the outer engaging section 17 to the outer surface 4b11 of the engaged section 4b1. Hence, the reaction force receiving portion can reliably receive the reaction force F2 from the outer surface 4b11 with the protrusion 19 being in the outer surface 4b11 of the engaged section 4b1.

(3) In the seat 1 in the embodiment, the reaction force receiving portion further includes the distal end 17a that tilts in addition to the protrusion 19. In this configuration, the reaction force receiving portion further includes the distal end 17a of the outer engaging section 17 that tilts in a direction toward the outer surface 4b11 of the engaged section 4b1 relative to the direction in which the cover attachment part 12 extends. Hence, the reaction force receiving portion can reliably receive the reaction force F2 from the outer surface 4b11 with the tilting distal end 17a and the protrusion 19 being in the outer surface 4b11 of the engaged section 4b1.

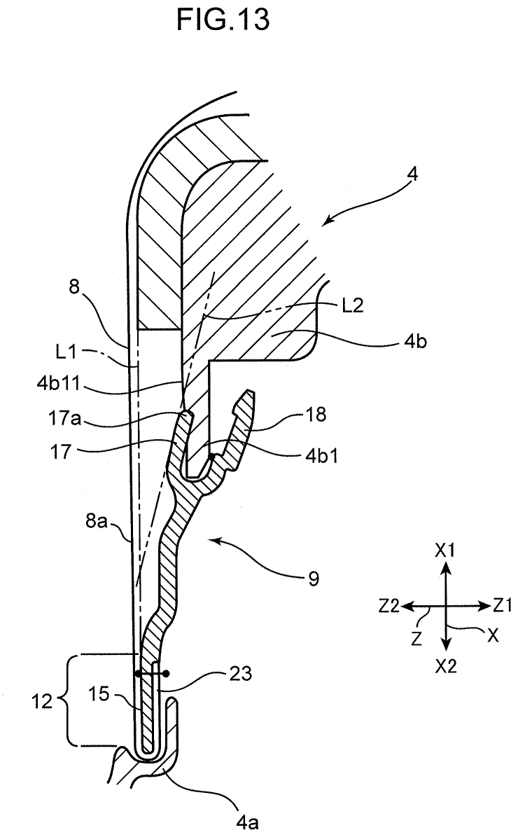

In a modification of the present invention, as illustrated in FIG. 13, the reaction force receiving portion can reliably receive the reaction force F2 from the outer surface 4b11 even without the protrusion 19 at the outer engaging section 17 as long as the reaction force receiving portion includes the distal end 17a of the outer engaging section 17 that tilts in a direction toward the outer surface 4b11 of the engaged section 4b1 relative to a direction in which the cover attachment part 12 extends.

Here, the outer engaging section 17 may be arranged so as to extend along a line L2 tilting in a direction toward the inner engaging section 18 relative to an extension line L1 of the flat section 15 of the cover attachment part 12 so that the distal end 17a of the outer engaging section 17 tilts in a direction toward the outer surface 4b11 of the engaged section 4b1 relative to the direction in which the cover attachment part 12 extends.

(4) In the seat 1 in the embodiment, the cover attachment part 12 has the flat section 15 that linearly guides the cover end 8a rearward X2. This configuration achieves a uniformly kept external appearance of the seat 1 owing to the cover end 8a extending along the flat section 15 (see FIG. 5) of the cover attachment part 12.

(5) In the seat 1 in the embodiment, the cover end 8a is fixed in a state of wrapping around the cover attachment part 12. This configuration achieves firm fixing of the cover end 8a to the cover attachment part 12. The configuration further allows a line of a seam P between the cover end 8a and another part, specifically, the lower constituent part 4a of the base body 4 illustrated in FIG. 3 to FIG. 4 in the embodiment, to clearly and distinctly come out.

(6) In the seat 1 in the embodiment, the cover attachment part 12 has such a thickness as to allow the cover end 8a to be sewn to the cover attachment part 12. This configuration facilitates the sewing of the cover end 8a to the cover attachment part 12. The configuration further allows the line of the seam P (see FIG. 3 to FIG. 4) between the cover end 8a and another part (the lower constituent part 4a) to more clearly and distinctly come out.

(7) In the seat 1 in the embodiment, as illustrated in FIG. 3 to FIG. 4, the base body 4 includes the armrest accommodation part 7 that accommodates the armrest 6 at a position adjacent to the outside of (located downward Z2 from) the cover end 8a. The fixing member 9 is formed of a long band-shaped member extending in the second direction D2 perpendicularly intersecting the first direction D1 (see FIG. 6) in which the cover attachment part 12 and the engaging part 13 align. The band-shaped member constituting the fixing member 9 has the slit 22 (see FIG. 6 to FIG. 7) around the central portion thereof in the second direction D2 (width direction Y of the seat 1 in the embodiment), the slit 22 resulting from removing the engaging part 13 in the central portion. Thus, in insertion of the fingers FR (see FIG. 12) of the user of the seat 1 into the gap between the armrest 6 and the cover end 8a to take the armrest 6 out from the armrest accommodation part 7 of the base body, the cover end 8a flexes to the inside of the base body 4 (upward Z1) in the slit 22 of the fixing member 9. The flexure facilitates the insertion of the fingers FR into the gap, that is, improves finger insertion performance. This configuration consequently facilitates taking-out of the armrest 6 from the armrest accommodation part 7.

(8) In the seat 1 in the embodiment, the fixing member 9 includes the connection arm part 14 that connects the cover attachment part 12 and the engaging part 13 to each other therebetween. The connection arm part 14 has the stepped portion 21 curving in a direction away from the cover end 8a. As illustrated in FIG. 12, in insertion of the fingers FR of the user of the seat 1 into the gap between the armrest 6 and the cover end 8a to take the armrest 6 out from the armrest accommodation part 7 of the base body 4, the cover end 8a flexes toward the inside of the base body 4 (upward Z1). The flexure facilitates the insertion of the fingers FR into the gap, that is, improves finger insertion performance. This configuration consequently facilitates taking-out of the armrest 6 from the armrest accommodation part 7.

(9) In the seat 1 in the embodiment, as illustrated in FIG. 5, the inner engaging section 18 has the slanting surface 18a slanting in a direction away from the inner surface 4b12 of the engaged section 4b1 as advancing toward the distal end of the inner engaging section 18.

This configuration makes the slanting surface 18a of the inner engaging section 18 guide the engaged section 4b1 at engaging of the engaging part 13 of the fixing member 9 with the engaged section 4b1. Thus, the engaging part 13 easily engages with the engaged section 4b1 by sandwiching the engaged section 4b1 between the inner engaging section 18 and the outer engaging section 17. This improves the workability in the work of engaging the fixing member 9 with the engaged section 4b1.

(10) In the seat 1 in the embodiment, as illustrated in FIG. 5, the inner protrusion 20 is at the proximal end of the inner engaging section 18. In this configuration, in the state where the cover attachment part 12 receives the tensile force T of the cover 8 in the direction toward the front surface 4b2 of the upper constituent part 4b, the inner protrusion 20 at the proximal end of the inner engaging section 18 is pressed to the inner surface 4b12 around the leading end of the engaged section 4b1. The pressing brings the inner protrusion 20 into point contact with the inner surface 4b12 (see the contact point CP) of the engaged section 4b1 to be in the inner surface 4b12. Accordingly, the inner protrusion 20 is unlikely to be displaced and can stably serve as a fulcrum. As a result, the configuration achieves more stable fixing of the cover end 8a.

(11) In the seat 1 in the embodiment, as illustrated in FIG. 5, the lower constituent part 4a of the base body 4 has the engagement section 4a2 with which the leading end of the cover attachment part 12 of the fixing member 9 engages. This configuration in which the leading end of the cover attachment part 12 of the fixing member 9 engages with the engagement section 4a2 of the lower constituent part 4a of the base body 4 can prevent the cover attachment part 12 from coming off.

(12) As described above, in the configuration of the fixing member 9 in the embodiment, the engaging part 13 engaging with the engaged section 4b1 is less likely to disengage therefrom even when the cover attachment part 12 receives the tensile force T of the cover 8 in the direction toward the front surface 4b2 of the upper constituent part 4b. Specifically, the engaging part 13 includes the outer engaging section 17 being in contact with the outer surface 4b11 of the engaged section 4b1 and the inner engaging section 18 being in contact with the inner surface 4b12 of the engaged section 4b1, and engages with the engaged section 4b1 in the state of sandwiching the engaged section 4b1 between the outer engaging section 17 and the inner engaging section 18. The inner engaging section 18 has the inner protrusion 20 protruding to the inner surface 4b12 of the engaged section 4b1. The outer engaging section 17 has, at the distal end 17a thereof, the protrusion 19 constituting the reaction force receiving portion that receives the reaction force F2 from the outer surface 4b11 of the engaged section 4b1.

As illustrated in FIG. 8, the fixing member 9 in the embodiment is configured such that, when the engaging part 13 engages with the engaged section 4b1 in the state of sandwiching the engaged section 4b1 between the outer engaging section 17 and the inner engaging section 18 while the cover end 8a attached to the cover attachment part 12 is tensioned, the tensile force T is generated at the cover end 8a in a direction toward the front surface 4b2 (frontward X1) of the upper constituent part 4b of the base body 4. The inner protrusion 20 of the inner engaging section 18 is pressed (see the pressing force F1) to the inner surface 4b12 (specifically, to the slope 4b13 at the leading end of the inner surface 4b12) of the engaged section 4b1 at the contact point CP to be the fulcrum in response to the tensile force T.

At this time, as illustrated in FIG. 9, the protrusion 19 (or the reaction force receiving portion) at the distal end of the outer engaging section 17 is pressed to the outer surface 4b11 of the engaged section 4b1 to receive the reaction force F2 from the outer surface 4b11 and to be the point of effort. The protrusion 19 gives the acting force F3 onto the cover attachment part 12 with the reaction force F2 in the direction (the up-down direction Z in FIG. 10) perpendicularly intersecting the direction of the tensile force T and toward the engaged section 4b1 (upward Z1).

As illustrated in FIG. 11, this achieves the balance between the rotation moment M1 based on the tensile force T of the cover 8 received by the cover attachment part 12 about the contact point CP at the inner protrusion 20 as the rotation center and the rotation moment M2 based on the acting force F3 acting onto the cover attachment part 12.

The balance between the two rotation moments M1, M2 applied to the cover attachment part 12 in the fixing member 9 prevents the fixing member 9 from rotating. This enables the engaging part 13 of the fixing member 9 to sandwich the engaged section 4b1 of the base body between the outer engaging section 17 and the inner engaging section 18 from inside and outside and to maintain the state of engaging with the engaged section, so that the engaging part 13 is prevented from disengaging from the engaged section 4b1. The configuration eventually eliminates the need for a retainer at the engaged section 4b1 independently of the fixing member 9, and thus achieves stable fixing of the cover end 8a only by the fixing member 9 without increasing the number of components of the seat 1.

### SUMMARY OF THE EMBODIMENT

The embodiment is summarized in the following manner.

A seat in the embodiment includes: a base body; a cover that covers a front surface of the base body; and a cover fixing member that fixes an end of the cover to the base body at an end of a rear surface of the base body. The base body has an engaged section protruding rearward from the end of the rear surface of the base body, and having an outer surface facing an outside the base body and an inner surface facing an inside of the base body. The end of the cover extends toward a rear of the base body over the engaged section. The cover fixing member includes: a cover attachment part to which the end of the cover is attached; and an engaging part that is closer to the engaged section than the cover attachment part and engages with the engaged section. The end of the cover engages with the engaged section via the cover attachment part. The engaging part has an outer engaging section being in contact with the outer surface of the engaged section and an inner section being in contact with the inner surface of the engaged section. The inner engaging section has an inner protrusion protruding to the inner surface of the engaged section. The outer engaging section has, at a distal end thereof, a reaction force receiving portion that receives a reaction force from the outer surface of the engaged section. The engaging part is configured to engage with the engaged section in a state of sandwiching the engaged section between the outer engaging section and the inner engaging section so that the reaction force receiving portion receives the reaction force from the outer surface of the engaged section about the inner protrusion as a fulcrum in response to a tensile force of the cover. The reaction force receiving portion is configured to give an acting force onto the cover attachment part with the reaction force in a direction perpendicularly intersecting a direction of the tensile force and toward the engage part, and receive the reaction force to keep a balance between a rotation moment based on the tensile force of the cover received by the cover attachment part about the inner protrusion as a rotation center and a rotation moment based on the acting force acting onto the cover attachment part.

In this configuration, the seat includes the cover fixing member that fixes the end of the cover to the base body by engaging with the engaged section protruding rearward from the end of the rear surface of the base body. In the configuration of the cover fixing member, the engaging part engaging with the engaged section is less likely to disengage therefrom even when the cover attachment part receives the tensile force of the cover in a direction toward the front surface of the base body. Specifically, the engaging part has the outer engaging section being in contact with the outer surface of the engaged section and the inner engaging section being in contact with the inner surface of the engaged section. The engaging part engages with the engaged section in a state of sandwiching the engaged section between the outer engaging section and the inner engaging section. The inner engaging section has the inner protrusion protruding to the inner surface of the engaged section. The outer engaging section has, at the distal end thereof, the reaction force receiving portion that receives a reaction force from the outer surface of the engaged section.

When the engaging part engages with the engaged section in the state of sandwiching the engaged section between the outer engaging section and the inner engaging section, the tensile force is generated at the end of the cover in the direction toward the front surface of the base body. The inner protrusion is pressed to the inner surface of the engaged section to be the fulcrum and the reaction force receiving portion is pressed to the outer surface of the engaged section to receive the reaction force from the outer surface of the engaged section and to be the point of effort in response to the tensile force. The reaction force receiving portion gives an acting force onto the cover attachment part with the reaction force in the direction perpendicularly intersecting the direction of the tensile force and toward the engage part, and receives the reaction force to keep a balance between a rotation moment based on the tensile force of the cover received by the cover attachment part about the inner protrusion as a rotation center and a rotation moment based on the acting force acting onto the cover attachment part.

The balance between the two rotation moments applied to the cover attachment part in the cover fixing member prevents the fixing member from rotating. This enables the engaging part of the cover fixing member to sandwich the engaged section of the base body between the outer engaging section and the inner engaging section from inside and outside and to maintain the state of engaging with the engaged section, so that the engaging section is prevented from disengaging from the engaged section. The configuration eventually eliminates the need for a retainer at the engaged section independently of the cover fixing member, and thus achieves stable fixing of the end of the cover only by the cover fixing member without increasing the number of components of the seat.

In the seat, the reaction force receiving portion preferably includes a protrusion protruding from the distal end of the outer engaging section to the outer surface of the engaged section.

In this configuration, the reaction force receiving portion of the outer engaging section includes the protrusion protruding from the distal end of the outer engaging section to the outer surface of the engaged section, and thus can reliably receive the reaction force from the outer surface with the protrusion being in the outer surface of the engaged section.

In the seat, the reaction force receiving portion preferably includes the distal end of the outer engaging section, the distal end tilting in a direction toward the outer surface of the engaged section relative to a direction in which the cover attachment part extends.

In this configuration, the reaction force receiving portion of the outer engaging section includes the distal end of the outer engaging section that tilts in the direction toward the outer surface of the engaged section relative to the direction in which the cover attachment part extends, and thus can reliably receive the reaction force from the outer surface with the tilting distal end being in the outer surface of the engaged section.

In the seat, the cover attachment part preferably has a flat section that linearly guides the end of the cover rearward.

This configuration achieves a uniformly kept external appearance of the seat owing to the end of the cover extending along the flat section of the cover attachment part.

In the seat, the end of the cover is preferably fixed in a state of wrapping around the cover attachment part.

The configuration in which the end of the cover is fixed in the state of wrapping around the cover attachment part enables the end of the cover to be firmly fixed to the cover attachment part. The configuration further allows a line of a seam between the end of the cover and another part to clearly and distinctly come out.

In the seat, the cover attachment part preferably has such a thickness as to allow the end of the cover to be sewn to the cover attachment part.

This configuration facilitates the sewing of the end of the cover to the cover attachment part. The configuration further allows the line of the seam between the end of the cover and another part to more clearly and distinctly come out.

In the seat, the base body preferably includes an armrest accommodation part that accommodates an armrest at a position adjacent to an outside of the end of the cover. The cover fixing member is preferably formed of a long band-shaped member extending in a second direction perpendicularly intersecting a first direction in which the cover attachment part and the engaging part align. The band-shaped member preferably has a slit around a central portion thereof in the second direction, the slit resulting from removing the engaging part in the central portion.

This configuration includes the slit around the central portion thereof in the direction (second direction) in which the band-shaped member constituting the cover fixing member extends. Thus, in insertion of the fingers of the user of the seat into the gap between the armrest and the cover attachment part to take the armrest out from the armrest accommodation part of the base body, the cover end flexes to the inside of the base body in the slit of the fixing member. The flexure facilitates the insertion of the fingers into the gap, that is, improves finger insertion performance. This configuration consequently facilitates taking-out of the armrest from the armrest accommodation part.

In the seat, the base body preferably includes an armrest accommodation part that accommodates an armrest at a position adjacent to an outside of the end of the cover. The cover fixing member preferably further includes a connection arm part that connects the cover attachment part and the engaging part to each other therebetween. The connection arm part preferably has the stepped portion curving in a direction away from the end of the cover.

In the configuration, the connection arm part that connects the cover attachment part and the engaging part to each other therebetween in the cover fixing member has the stepped portion, and the stepped portion curves in a direction away from the end of the cover. Thus, in insertion of the fingers of the user of the seat into the gap between the armrest and the cover attachment part to take the armrest out from the armrest accommodation part of the base body, the end of the cover flexes to the inside of the base body at the stepped portion of the fixing member. The flexure facilitates the insertion of the fingers into the gap, that is, improves finger insertion performance. This configuration consequently facilitates taking-out of the armrest from the armrest accommodation part.

In the seat, the inner engaging section preferably has a slanting surface slanting in a direction away from the inner surface of the engaged section as advancing toward a distal end of the inner engaging section. This configuration makes the slanting surface of the inner engaging section guide the engaged section at engaging of the engaging part of the cover fixing member with the engaged section. Thus, the engaging part easily engages with the engaged section by sandwiching the engaged section between the inner engaging section and the outer engaging section. This improves the workability in the work of engaging the cover fixing member with the engaged section.

In the seat, the inner protrusion is preferably at a proximal end of the inner engaging section.

In this configuration, in the state where the cover attachment part receives the tensile force of the cover in the direction toward the front surface of the base body, the inner protrusion at the proximal end of the inner engaging section is pressed to the inner surface around the leading end of the engaged section. The pressing brings the inner protrusion into point contact with the inner surface of the engaged section to be in the inner surface. Accordingly, the inner protrusion is unlikely to be displaced and can stably serve as a fulcrum. As a result, the configuration achieves more stable fixing of the end of the cover.

In the seat, the base body preferably further has an engagement section with which a distal end of the cover attachment part of the cover fixing member engages.

This configuration in which the leading end of the cover attachment part of the fixing member engages with the engagement section of the lower constituent part of the base body can prevent the cover attachment part from coming off.

A cover fixing member in the embodiment is a cover fixing member that is configured to fix a cover that covers a front surface of a base body in a seat to an engaged section protruding rearward from an end of a rear surface of the base body. The cover fixing member includes: a cover attachment part having such a shape as to receive an end of the cover attached thereto; and an engaging part to engage with the engaged section of the base body. The engaging part has an outer engaging section and an inner engaging section being apart from each other to sandwich the engaged section from an outside and an inside of the base body. The inner engaging section has an inner protrusion protruding inward in a space between the outer engaging section and the inner engaging section. The outer engaging section has, at a distal end thereof, a reaction force receiving portion configured to receive a reaction force from the outer surface of the engaged section. The cover fixing member is configured such that, when the engaging part engages with the engaged section in a state of sandwiching the engaged section between the outer engaging section and the inner engaging section, a tensile force is generated at the end of the cover in a direction toward the front surface of the base body, and that the inner protrusion is pressed to an inner surface of the engaged section to be a fulcrum and the reaction force receiving portion is pressed to an outer surface of the engaged section to receive a reaction force and to be a point of effort in response the tensile force. The reaction force receiving portion is configured to give an acting force onto the cover attachment part with the reaction force in a direction perpendicularly intersecting a direction of the tensile force and toward the engage part, and receive the reaction force to keep a balance between a rotation moment based on the tensile force of the cover received by the cover attachment part about the inner protrusion as a rotation center and a rotation moment based on the acting force acting onto the cover attachment part.

In the configuration of the cover fixing member to fix the end of the cover to the base body, the engaging part engaging with the engaged section is less likely to disengage therefrom even when the cover attachment part receives the tensile force of the cover in the direction toward the front surface of the base body. Specifically, the engaging part has the outer engaging section and the inner engaging section being apart from each other to define a space therebetween to sandwich the engaged section in the space. The inner engaging section has the inner protrusion protruding inward in the space. The outer engaging section has, at the distal end thereof, the reaction force receiving portion configured to receive a reaction force from the outer surface of the engaged section.

In the cover fixing member, when the engaging part engages with the engaged section in the state of sandwiching the engaged section between the outer engaging section and the inner engaging section, a tensile force is generated at the end of the cover in the direction toward the front surface of the base body, and the inner protrusion is pressed to the inner surface of the engaged section to be a fulcrum and the reaction force receiving portion is pressed to the outer surface of the engaged section to receive a reaction force and to be a point of effort in response to the tensile force. The reaction force receiving portion gives an acting force onto the cover attachment part with the reaction force in the direction perpendicularly intersecting the direction of the tensile force and toward the engage part, and receives the reaction force to keep a balance between a rotation moment based on the tensile force of the cover received by the cover attachment part about the inner protrusion as a rotation center and a rotation moment based on the acting force acting onto the cover attachment part.

The balance between the two rotation moments applied to the cover attachment part in the cover fixing member prevents the fixing member from rotating. This enables the engaging part of the cover fixing member to sandwich the engaged section of the base body between the outer engaging section and the inner engaging section from inside and outside and to maintain the state of engaging with the engaged section, so that the engaging section is prevented from disengaging from the engaged section. This achieves stable fixing of the end of the cover only by the cover fixing member without increasing the number of components of the seat.

Conclusively, the seat and the cover fixing member in the embodiment achieves stable fixing of the end of the cover only by the fixing member without increasing the number of components of the seat.

1. A seat, comprising:
a base body;
a cover that covers a front surface of the base body; and
a cover fixing member that fixes an end of the cover to the base body at an end of a rear surface of the base body, wherein
the base body has an engaged section protruding rearward from the end of the rear surface of the base body, and having an outer surface facing an outside of the base body and an inner surface facing an inside of the base body,
the end of the cover extends toward a rear of the base body over the engaged section,
the cover fixing member includes:
a cover attachment part to which the end of the cover is attached; and
an engaging part that is closer to the engaged section than the cover attachment part and engages with the engaged section,
the end of the cover is engaged with the engaged section via the cover attachment part,
the engaging part has an outer engaging section being in contact with the outer surface of the engaged section and an inner section being in contact with the inner surface of the engaged section,
the inner engaging section has an inner protrusion protruding to the inner surface of the engaged section,
the outer engaging section has, at a distal end thereof, a reaction force receiving portion that receives a reaction force from the outer surface of the engaged section,
the engaging part is configured to engage with the engaged section in a state of sandwiching the engaged section between the outer engaging section and the inner engaging section so that the reaction force receiving portion receives the reaction force from the outer surface of the engaged section about the inner protrusion as a fulcrum in response to a tensile force of the cover, and
the reaction force receiving portion is configured to give an acting force onto the cover attachment part with the reaction force in a direction perpendicularly intersecting a direction of the tensile force and toward the engage part, and receive the reaction force to keep a balance between a rotation moment based on the tensile force of the cover received by the cover attachment part about the inner protrusion as a rotation center and a rotation moment based on the acting force acting onto the cover attachment part.

2. The seat according to claim 1, wherein the reaction force receiving portion includes a protrusion protruding from the distal end of the outer engaging section to the outer surface of the engaged section.

3. The seat according to claim 1, wherein the reaction force receiving portion includes the distal end of the outer engaging section, the distal end tilting in a direction toward the outer surface of the engaged section relative to a direction in which the cover attachment part extends.

4. The seat according to claim 1, wherein the cover attachment part has a flat section that linearly guides the end of the cover rearward.

5. The seat according to claim 1, wherein the end of the cover is fixed in a state of wrapping around the cover attachment part.

6. The seat according to claim 5, wherein the cover attachment part has such a thickness as to allow the end of the cover to be sewn to the cover attachment part.

7. The seat according to claim 1, wherein the base body includes an armrest accommodation part that accommodates an armrest at a position adjacent to an outside of the end of the cover,
the cover fixing member is formed of a long band-shaped member extending in a second direction perpendicularly intersecting a first direction in which the cover attachment part and the engaging part align, and
the band-shaped member has a slit around a central portion thereof in the second direction, the slit resulting from removing the engaging part in the central portion.

8. The seat according to claim 1, wherein the base body includes an armrest accommodation part that accommodates an armrest at a position adjacent to an outside of the end of the cover,
the cover fixing member further includes a connection arm part that connects the cover attachment part and the engaging part to each other therebetween, and
the connection arm part has a stepped portion curving in a direction away from the end of the cover.

9. The seat according to claim 1, wherein the inner engaging section has a slanting surface slanting in a direction away from the inner surface of the engaged section as advancing toward a distal end of the inner engaging section.

10. The seat according to claim 1, wherein the inner protrusion is at a proximal end of the inner engaging section.

11. The seat according to claim 1, wherein the base body further has an engagement section with which a leading end of the cover attachment part of the cover fixing member engages.

12. A cover fixing member that is configured to fix a cover that covers a front surface of a base body in a seat to an engaged section protruding rearward from an end of a rear surface of the base body, the cover fixing member comprising:
a cover attachment part having such a shape as to receive an end of the cover to be attached thereto; and
an engaging part to engage with the engaged section of the base body, wherein
the engaging part has an outer engaging section and an inner engaging section being apart from each other to sandwich the engaged section from an outside and an inside of the base body,
the inner engaging section has an inner protrusion protruding inward in a space between the outer engaging section and the inner engaging section,
the outer engaging section has, at distal end thereof, a reaction force receiving portion configured to receive a reaction force from the outer surface of the engaged section,
the cover fixing member is configured such that, when the engaging part engages with the engaged section in a state of sandwiching the engaged section between the outer engaging section and the inner engaging section, a tensile force is generated at the end of the cover in a direction toward the front surface of the base body, and that the inner protrusion is pressed to an inner surface of the engaged section to be a fulcrum and the reaction force receiving portion is pressed to an outer surface of the engaged section to receive a reaction force and to be a point of effort in response the tensile force, and
the reaction force receiving portion is configured to give an acting force onto the cover attachment part with the reaction force in a direction perpendicularly intersecting a direction of the tensile force and toward the engage part, and receive the reaction force to keep a balance between a rotation moment based on the tensile force of the cover received by the cover attachment part about the inner protrusion as a rotation center and a rotation moment based on the acting force acting onto the cover attachment part.
